(19) United States
(12) Patent Application Publication
(10) Pub. No.: US 2012/0272339 A1
(43) Pub. Date: Oct. 25, 2012

(54) METHOD AND SYSTEM FOR ACCESSING PASSWORD-PROTECTED DATA ON A DEVICE

(76) Inventors: Ganesan Kumaravel, Bangalore (IN); Kumar Thangapandian Palani, Bangalore (IN)

(21) Appl. No.: 13/157,317

(22) Filed: Jun. 10, 2011

(30) Foreign Application Priority Data
Apr. 25, 2011 (IN) 1432/CHE/2011

(51) Int. Cl. G06F 21/24

(52) U.S. Cl. 726/30

(57) ABSTRACT

A password is stored to be associated with a sender sending data for exploitation on a network-connected device associated with a user. Password-protected data is received from the sender via a network connection. The password-protected data is automatically retrieved to access the password-protected data and the accessed data is sent via network connection to a device associated with the user.

### RELATED APPLICATION

Benefit is claimed under 35 U.S.C. 119(a)-(d) to Foreign application Serial No. 1432/CHE/2011, filed in INDIA entitled “METHOD AND SYSTEM FOR ACCESSING PASSWORD-PROTECTED DATA ON A DEVICE” by Hewlett-Packard Development Company, L.P., filed on Apr. 25, 2011, which is herein incorporated in its entirety by reference for all purposes.

### BACKGROUND

Electronic documents and other data for home, business and personal use are ubiquitous. Such electronic documents and data are frequently printed with a printer. In some cases, electronic documents are password-protected such that they require a password (e.g., entered by a user) before they can be accessed (e.g., opened, viewed, printed, etc.).

### BRIEF DESCRIPTION OF DRAWINGS

The following description includes discussion of figures having illustrations given by way of example of implementations of embodiments of the invention. The drawings should be understood by way of example, not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram illustrating a system according to various embodiments.

FIG. 2 is a block diagram illustrating a system according to various embodiments.

FIG. 3 is a flow diagram of operation in a system according to various embodiments.

FIG. 4 is a flow diagram of operation in a system according to various embodiments.

### DETAILED DESCRIPTION

One way to print a password-protected document is for a user to open the document with an appropriate application and then provide the password in response to a prompt or other notification request for the password. Once the document has been opened, the user may print the document (e.g., by selecting a printer connected to the computing device hosting the application and generating a print job for that printer).

Various web-connected printers now offer support for printing through email. This enables a user to send an email to a printer with data (e.g., an attachment) to be printed and the printer will print the data. However, existing web-connected printers lack the ability to handle email print requests that include password-protected data, documents, and/or attachments. Embodiments provided herein enable printing of password-protected data via email to a printing device.

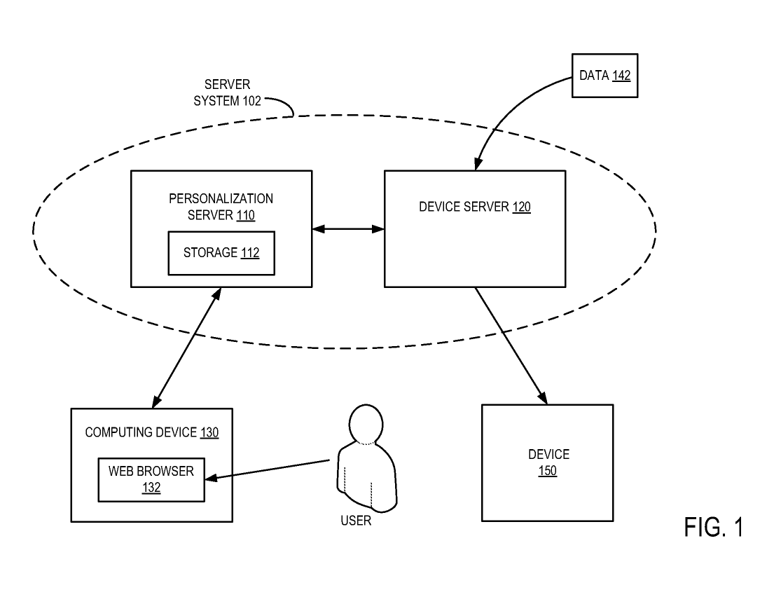

FIG. 1 is a block diagram illustrating a system according to various embodiments. FIG. 1 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

As shown, server system 102 includes a personalization server 110 and a device server 120. As illustrated by the dotted line, the servers within server system 102 can be hosted on a single physical device or they can be distributed across multiple physical devices connected over a network (e.g., the Internet), such as in a cloud computing infrastructure. Personalization server 110 includes storage 112 to store a password string provided by a user.

In various embodiments, a user may have a web-accessible user account to manage the flow of data to one or more devices (e.g., device 150) connected with the server system and associated with the user or the user account. For example, a user might manage a web-connected printing device via the user account. As shown, the user may access the user account via a web browser 132 on a computing device 130. As part of customizing or personalizing the user account, the user may enter one or more passwords to be used in accessing password-protected data sent to devices associated with the user. As mentioned above, passwords provided by the user are stored and maintained by personalization server 110 in storage 112.

In various embodiments, each password stored in storage 112 is associated with a sender. Thus, when a sender (e.g., a third party sender of data, documents, etc.) sends password-protected data 142 intended for a user device (e.g., device 150), the password-protected data 142 is received by device server 120. Device server 120 automatically contacts personalization server 110 to obtain the stored password associated with the sender. Device server 120 accesses the password-protected data with the password obtained from personalization server 110. Device server 120 sends the accessed data to the intended device (e.g., device 150) where the data may be exploited, consumed or otherwise used. For example, device 150 may be a printing device; thus, by receiving accessed data from device server 120, device 150 can print the data.

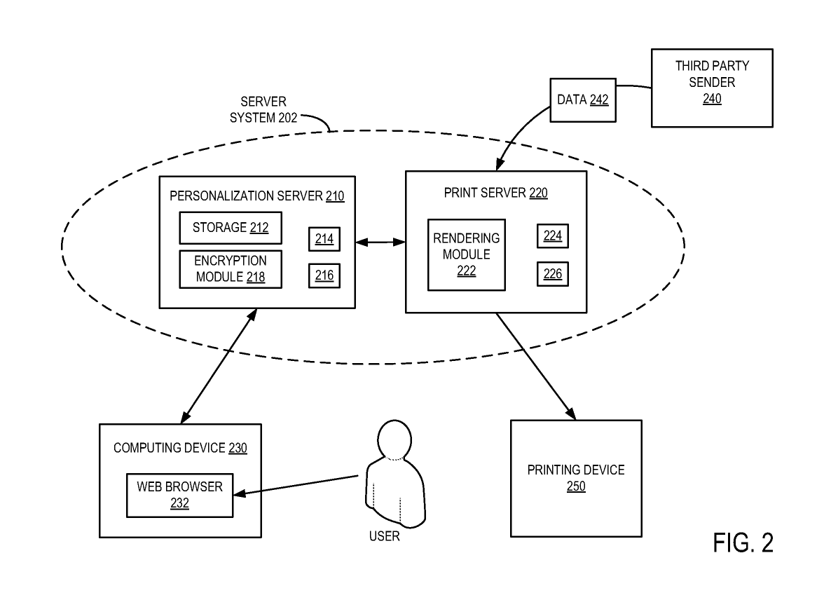

FIG. 2 is a block diagram illustrating a server system according to various embodiments. FIG. 2 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

The server system 202 of FIG. 2 includes personalization server 210 and a print server 220. As illustrated by the dotted line, the servers within server system 202 can be hosted on a single physical device or they can be distributed across multiple physical devices connected over a network (e.g., the Internet), such as in a cloud computing infrastructure.

In various embodiments, a user may access, via web browser 232, a user account to manage print jobs sent to printing devices associated with the user or the user account. For example, printing device 250 might be owned and/or managed by the user, as shown. From the user account, the user may configure various settings, including permissions for sending print jobs to printing device 250. In various embodiments, print jobs may be sent to printing device 250 by sending an email to printing device 250, the email including an attachment or data in the body of the email to be printed. Within the user account, the user may create a list of domains or email addresses that are permitted to send print jobs to printing device 250. Configuration settings and other data associated with the user account may be maintained in storage 212 or other location within server system 202.

In addition to creating a permissions list, the user may provide one or more passwords to be associated with particular senders on the permissions list. Such passwords may be provided by the user via the web-accessible user account and stored in storage 212. The user account could also be updated via mobile apps, widgets, text messages, email, etc in alternate embodiments.

In an example, third party sender 240 is a bank that sends monthly transaction statements (data 242) to its customers via email. The monthly transaction statements are attached to the email as a password-protected PDF (Portable Document Format) document. Given the recurring nature of the PDF statements, the password to access the PDF statements would normally be known to the user (e.g., password is the same for all statements sent by third party sender). If the user wants the statements sent directly to printer 250 for printing, the user provides the email address of printer 250 to third party sender 240 and adds third party sender 240 to the user's permissions list. In addition, the user may store the password for accessing the password-protected monthly statements and associate the password with third party sender 240. Accordingly, the password is sent to personalization server 210 where it is stored in storage 212. In various embodiments, an encryption module 218 encrypts the password prior to being stored in storage 212 and decrypts the password upon retrieval from storage 212 for use in accessing password-protected data and/or documents received from third party sender 240.

Thus, when third party sender 240 sends (e.g., via email) password-protected data 242 for printing on printing device 250, print server 220 receives data 242 and determines that the data is password-protected. Accordingly, print server 220 contacts (e.g., via network connection) personalization server 210 and requests the password associated with third party sender 240 (e.g., associated with the domain or email address of third party sender 240). Once obtained, print server 220 automatically accesses the password-protected data with the password. Rendering module 222 renders the accessed data into a format suitable for printing by printing device 250. Print server 220 sends rendered print data to print device 250 where it is printed.

In some embodiments, personalization server 210 may store multiple passwords associated with third party sender 240. For example, if third party sender 240 is a bank, the user may have both a personal account and a business account with the bank. Accordingly, the user may have separate passwords for accessing password-protected documents for the personal and business accounts. Thus, when print server 220 receives password-protected data from third party sender 240 and requests the password from personalization server 210, personalization server 210 may provide the multiple passwords associated with third party sender (e.g., one by one or as a group) to print server 220. In this way, printer server 220 may attempt to access the password-protected data with different passwords until a successful attempt is made. For example, printer server 220 could try the passwords one by one until a successful attempt is made. If a successful attempt is made at accessing the data prior to trying all passwords, any remaining passwords are ignored and/or discarded.

Stored passwords can be associated with a particular sender, user, printing device or some combination of these. For example, the user may have multiple printing devices (e.g., each with its own email address) connected to server system 202 and associated with the user's account. The user could thus configure his or her account such that the password could be retrieved for certain destination printing devices but not others.

In some cases, the user may have a generic email address that can be used to reach more than one printer connected to server system 202 based on various configuration filters, settings, routing parameters, etc. Thus, the user may associate a password with a particular condition or set of conditions as opposed to merely associating it with a sender or destination printer. For example, the user may specify that the password is retrievable for password-protected data sent from third party sender 240 to a first printer during a first time period of the day (e.g., 8:00 am-3:00 pm). The password may then be retrievable for password-protected data sent from third party 240 to a second printer during a second time period of the day (e.g., 4:00 pm-9:00 pm). Other conditions (e.g., associated with time, file size, printer availability, etc.) could be applied to passwords stored in personalization server 210 as well.

Various modules and/or components illustrated in FIG. 2 may be implemented as a computer-readable storage medium containing instructions executed by a processor (e.g., processor 214 or 224) and stored in a memory (e.g., memory 216 or 226) for performing the operations and functions discussed herein.

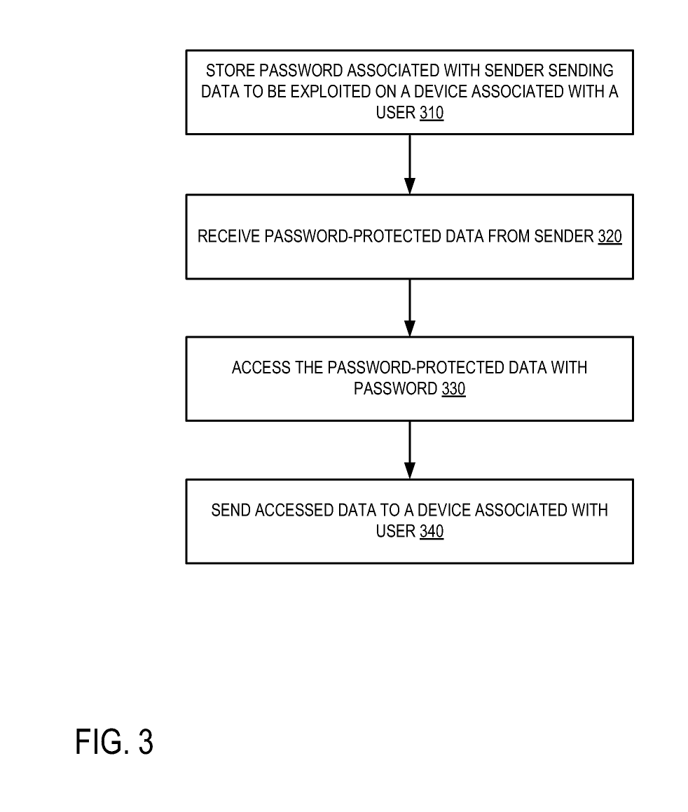

FIG. 3 is a flow diagram of operation in a system according to various embodiments. FIG. 3 includes particular operations and execution order according to certain embodiments. However, in different embodiments, other operations, omitting one or more of the depicted operations, and/or proceeding in other orders of execution may also be used according to teachings described herein.

A server system stores 310 a password string associated with a sender sending data to be exploited on a device associated with a user. Exploiting the data could involve printing print data with a printer, playing audio data on a device, playing video data on a device, or other exploitations of data on various computing devices (e.g., desktops, notebooks, smartphones, tablets, printers, smart appliances, etc.). In some embodiments, the server system may store multiple password strings associated with a sender.

The server system receives 320 password protected data from the sender via network connection (e.g., the Internet). For example, the sender might be an insurance provider and the password-protected data might be an insurance document. Upon receipt of the password-protected data, the server system accesses 330 the password-protected data with the password for the sender. Or, in embodiments where multiple passwords are stored, the server system attempts individual passwords until a successful attempt is made at accessing the data. The server system 340 sends the accessed data to a device associated with the user. In some embodiments, the data from the sender may specify a particular destination device associated with the user (e.g., the sender may send the data to a particular email address associated with a particular device). In other embodiments, the user may have multiple devices on the server system and the sender may not specify a particular device (e.g., a sender may send data to a generic email address associated with the user's account associated with the server system). In such cases, if the server system determines that the password-protected data is a document, the server system may send the document to a printer to be printed or to a display device for reading. Video data may be sent to a video playback device, audio files might be sent to an audio playback device, etc.

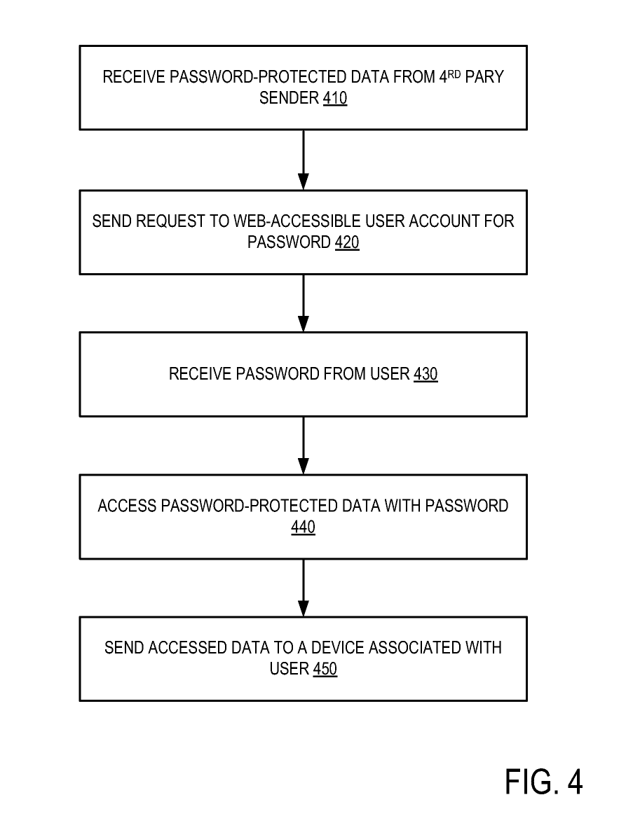

FIG. 4 is a flow diagram of operation in a system according to various embodiments. FIG. 4 includes particular operations and execution order according to certain embodiments. However, in different embodiments, other operations, omitting one or more of the depicted operations, and/or proceeding in other orders of execution may also be used according to teachings described herein.

A server system receives 410 password-protected data from a third-party sender via a network connection. The password-protected data is intended for exploitation on a device connected to the server system and associated with a user. Thus, when the sender addresses password-protected data to a device on the server, the server system receives it and may perform various operations on the data prior to forwarding it on the intended device. For example, in the case of password-protected data, the server system obtains the requisite password to access the data prior to providing it to the device.

In particular, the server system sends 420 a request to a web-accessible user account requesting the password rather than retrieving a previously stored password for accessing data from the sender. The password request may be received as a message in the inbox of the user account, to which the user may reply with the password upon logging into the user account and finding the message. In such cases, a queue of one or more password requests may accumulate in the user account, depending on how often the user accesses the user account to respond to password requests. The password request could also be sent to the user in other ways, such as, for example, by text message, email, instant messaging or other suitable communication format. Where the password-protected data is intended for a particular device, the password request could also be sent directly to the device, allowing the user to supply the password (e.g., via a user interface on the device).

When the user receives and responds to the password request, the server system receives 430 the password from the user. For example, the user may supply the password via the web-accessible user account, email, text messaging, instant messaging, or other suitable communication format. Upon receiving the password from the user, the server system accesses 440 the password-protected data. In various embodiments, the accessed data may be further manipulated by the server system. For example, where the password-protected data includes a document to be printed, the server system may render the document into a print ready format to be handled by a printer. Where the password-protected data is video, the video data may be re-sampled based on the video device's processing capabilities.

The server system sends 450 the accessed data to a device associated with the user. As mentioned above, the data may be addressed to a particular device associated with the user. However, in situations where the user has multiple devices connected to the server system, the data may be addressed more generally to the user or the user account on the server system. For example, the data may be sent to a generic email address associated with the user or user account as opposed to an email address specific to a particular device. In such situations, the user may define one or more profile configurations. For example, the user may configure his or her account to have received data sent to one of the user's devices based on the type of data (e.g., print data is sent to a printing device, audio data sent to an audio playback device, video to a video device, etc.). Other configurations may be based on timing, file size, device availability, etc.

Various modifications may be made to the disclosed embodiments and implementations of the invention without departing from their scope. Therefore, the illustrations and examples herein should be construed in an illustrative, and not a restrictive sense.

What is claimed is:

1. A method, comprising:
storing a password to be associated with a sender sending data for exploitation on a network-connected device associated with a user;
receiving password-protected data from the sender via a network connection, the password-protected data sent for exploitation on a network-connected device associated with the user;
automatically retrieving the stored password to access the password-protected data; and
sending, via network connection, the accessed data to a device associated with the user.

2. The method of claim 1, wherein storing the password comprises:
encrypting the password in conjunction with storing the password; and
wherein retrieving the password to access the password-protected data comprises decrypting the password in conjunction with retrieving the password.

3. The method of claim 1, wherein receiving password-protected data from the sender comprises receiving an email from the sender with the password-protected data.

4. The method of claim 1, further comprising:
storing multiple passwords associated with the sender; and
wherein the password-protected data is automatically accessed by attempting to access the password-protected data with respective stored passwords until a successful attempt is made to access the password-protected data.

5. The method of claim 1, wherein receiving password-protected data comprises receiving password-protected print data; and
wherein sending the accessed data to a device associated with the user comprises sending the accessed data to a printing device associated with the user.

6. A server system, comprising:
a personalization server having a memory to store a password string provided by a user via network connection, the password string to be associated with a sender of print data to be printed by a printing device associated with the user;
a device server to receive password-protected print data from the sender via network connection, the password-protected print data sent to be printed by a printing device associated with the user;
the device server to automatically obtain the stored password string and access the password-protected data with the password string in response to receiving the password-protected print data;
the device server to render the print data into a print ready format; and
the device server to send, via network connection, the rendered print data to a printing device associated with the user.

7. The server system of claim 6, the personalization server to store multiple password strings to be associated with the sender of print data and the device server further to attempt to access the password-protected print data with respective stored passwords, one by one, until a successful attempt is made to access the password-protected data.

8. The server system of claim 6, the personalization server to link the password string with a domain or email address of the sender.

9. The server system of claim 6, wherein the personalization server comprises an encryption module to encrypt the password string in conjunction with storing the password string and to decrypt the password string in response to the cloud print component requesting access to the password string.

10. A computer-readable data storage medium containing instructions that, when executed, cause a computer to:
receive password-protected data from a third-party sender via a network connection, the password-protected data sent to be exploited on a network-connected device associated with the user based at least in part on a profile configuration;
send a request, via network connection, to a web-accessible user account for a password to access the password-protected data;
receive user input including the password to access the password-protected data;
access the password-protected data with the password; and
send, via network connection, the accessed data to a device associated with the user based at least in part on a profile configuration.

11. The computer-readable data storage medium of claim 10, wherein the password-protected data comprises a document to be printed.

12. The computer-readable data storage medium of claim 10, wherein the instructions that cause the computer to send the request comprise further instructions that cause the computer to:
add the request to a queue of password requests, wherein each request in the queue is maintained by the web-accessible user account until user input is provided by the user in response to each request.
